(19) United States
(12) Patent Application Publication
(10) Pub. No.: US 2019/0221340 A1
(43) Pub. Date: Jul. 18, 2019

(54) METHOD OF MANUFACTURING PRESSED POWDER MAGNETIC CORE

(71) Applicant: TOYOTA JIDOSHA KABUSHIKI KAISHA, Toyota-shi (JP)

(72) Inventors: Naoki IWATA, Toyota-shi (JP); Shinjiro Saigusa, Toyota-shi (JP); Masafumi Suzuki, Miyoshi-shi (JP); Masaaki Nishiyama, Komaki-shi (JP); Jung Hwan Hwang, Nagakute-shi (JP); Masashi Ohtsubo, Nagakute-shi (JP)

(73) Assignee: TOYOTA JIDOSHA KABUSHIKI KAISHA, Toyota-shi (JP)

(21) Appl. No.: 16/244,518

(22) Filed: Jan. 10, 2019

(30) Foreign Application Priority Data
Jan. 12, 2018 (JP) 2018-003588

(51) Int. Cl. H01F 1/147; H01F 1/153; H01F 41/02; B22F 3/02

(52) U.S. Cl. CPC H01F 1/1475; H01F 1/15366; B22F 2003/023; B22F 3/02; H01F 41/02

(57) ABSTRACT

A method of manufacturing a pressed powder magnetic core disclosed herein may include: mixing soft magnetic metal particles, low-melting-point glass particles and lubricant and heating a mixture of the soft magnetic metal particles, the low-melting-point glass particles and the lubricant at a temperature that is higher than a melting point of the lubricant and is lower than a softening point of the low-melting-point glass particles so as to obtain powder of coated metal particles in which surfaces of the soft magnetic metal particles are coated by the lubricant and the low-melting-point glass particles are distributed in coating layers of the lubricant; filling a mold with the powder; press-molding the powder in the mold; and annealing the press-molded powder. In the pressed powder magnetic core, an amount of the low-melting-point glass particles may be 0.1 wt % to 5.0 wt % relative to an amount of the soft magnetic metal particles.

### CROSS-REFERENCE TO RELATED APPLICATION

This application claims priority to Japanese Patent Application No. 2018-003588 filed on Jan. 12, 2018, the contents of which are hereby incorporated by reference into the present application.

### TECHNICAL FIELD

The teaching disclosed herein relates to a method of manufacturing a pressed powder magnetic core used in a core of a reactor, for example.

### BACKGROUND

An example of a manufacturing method of a pressed powder magnetic core is described in Japanese Patent Application Publication No. 2017-45926. The manufacturing method is as follows. Magnetic metal particles, glass particles, and lubricant are mixed so as to obtain powder of coated metal particles in which the magnetic metal particles are coated with the glass particles and the lubricant. The powder is press-molded in a mold with a shape of a desired pressed powder magnetic core, and is then annealed. A temperature for molding the powder of the coated metal particles is higher than a melting point of the lubricant and is lower than a softening point of the glass particles. Lubricant for improving lubricity between particles may be called internal lubricant.

### SUMMARY

When a molded body is taken out from a mold, a pressure is applied to the molded body. The pressure upon the molded body being taken out is preferably small. To make this pressure small, it is preferable that an amount of lubricant is large. However, as the amount of the lubricant is increased, fluidity of powder of coated metal particles is lowered and filling the mold with the powder becomes difficult. The present disclosure relates to a manufacturing method of a pressed powder magnetic core, and provides a technique that can achieve good fluidity of powder of coated metal particles and ease of filling a mold with the powder.

A manufacturing method of a pressed powder magnetic core disclosed herein may comprise mixing soft magnetic metal particles, low-melting-point glass particles and lubricant and heating a mixture of the soft magnetic metal particles, the low-melting-point glass particles and the lubricant at a temperature that is higher than a melting point of the lubricant and is lower than a softening point of the low-melting-point glass particles so as to obtain powder of coated metal particles in which surfaces of the soft magnetic metal particles are coated by the lubricant and the low-melting-point glass particles are distributed in coating layers of the lubricant; filling a mold with the powder, press-molding the powder in the mold; and annealing the press-molded powder. In the manufacturing method disclosed herein, in the pressed powder magnetic core, an amount of the low-melting-point glass particles is 0.1 wt % to 5.0 wt % relative to an amount of the soft magnetic metal particles, and an amount of the lubricant is 0.1 wt % to 1.0 wt % relative to the amount of the soft magnetic metal particles. Further, in the pressed powder magnetic core, a mass of the low-melting-point glass particles is 0.5 to 20 times a mass of the lubricant.

By setting the amount of the lubricant and the amount of the low-melting-point glass particles in the above-described ranges, it is possible to increase fluidity of the powder of the coated metal particles and to make a pressure applied for taking the press-molded body out from the mold small.

The details and further improvements of the technique disclosed herein are described in the following “DETAILED DESCRIPTION”.

### BRIEF DESCRIPTION OF DRAWINGS

FIG. 1 is a flowchart of a manufacturing method according to an embodiment.

FIG. 2 is a graph representing a temperature and a heating time in a mixing and heating process.

FIG. 3 is a schematic diagram of metal particles coated with lubricant in which glass particles are distributed (embodiment).

FIG. 4 is a schematic diagram of metal particles coated with lubricant in which glass particles are distributed (comparative example: case with too many glass particles).

FIG. 5 is a schematic diagram of metal particles coated with lubricant in which glass particles are distributed (comparative example: case with too few glass particles).

FIG. 6 is a graph representing a relation between powder fluidity and density of a magnetic core (test piece).

FIG. 7 is a graph representing a relation between an amount of glass particles and strength of test piece.

FIG. 8 is a graph representing a relation between the amount of glass particles and the density of test piece.

FIG. 9 is a graph representing a relation between an amount of lubricant and a pressure for removing a mold.

FIG. 10 is a graph representing a relation between the amount of lubricant and the density of the magnetic core.

FIG. 11 is a graph representing a relation between a ratio of the amount of glass particles to the amount of lubricant and powder fluidity (the amount of lubricant=1.0 wt %).

FIG. 12 is a graph representing a relation between a ratio of the amount of glass particles to the amount of lubricant and powder fluidity (the amount of lubricant=0.1 wt %).

### DETAILED DESCRIPTION

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved method of manufacturing pressed powder magnetic core.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Features of the teaching disclosed herein will be described. The mass of the low-melting-point glass particles may be 0.5 to 3 times the mass of the lubricant. Further, in the manufacturing method disclosed herein, the powder may be press-molded in the mold while heating the mold at a temperature between 60 to 120 degrees Celsius. Press-molding in such a temperature range enables a pressure applied when the press-molded powder is taken out from the mold to be made small.

### Embodiment

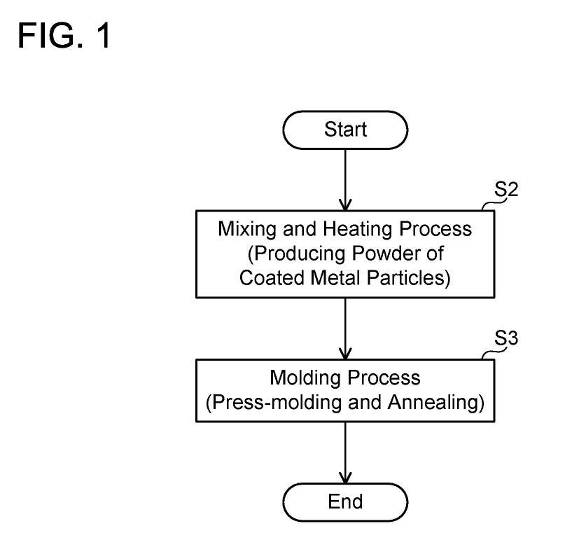

FIG. 1 is a flowchart of a manufacturing method according to an embodiment. The manufacturing method of the embodiment is a method of fabricating a magnetic core (a core) of a reactor. This manufacturing method includes a mixing and heating process (Step S2) and a molding process (Step S3).

(Mixing and Heating Process)

In the mixing and heating process, low-melting-point glass particles and lubricant are added to soft magnetic metal particles to obtain powder of the soft magnetic metal particles coated with the low-melting-point glass particles and the lubricant. Fe—Si—Al metal particles are used as the soft magnetic metal particles. Surfaces of the Fe—Si—Al metal particles are coated with an insulating material, such as aluminum oxide (Al₂O₃) or aluminum nitride (AlN).

Borosilicate glass particles, phosphate glass particles, and bismuth silicate glass particles can be used as the low-melting-point glass particles, for example. The low-melting-point glass particles mean glass particles that can be softened, deformed, or flow at a temperature of 600 degrees Celsius or less. Any low-melting-point glass particles can be used as long as a softening point thereof is higher than a heating temperature in mixing to be described later and is lower than an annealing temperature to be described later. An average particle diameter of the low-melting-point glass particles to be used is between 1 to 10 μm. An amount of the low-melting-point glass particles added is 0.1 wt % to 5.0 wt % relative to an amount of the soft magnetic metal particles. Hereinbelow, the low-melting-point glass particles will be simply referred to as glass particles.

As the lubricant, two or more kinds of lubricant having different melting points from each other are used. As the lubricant, fatty acid amide and higher alcohol can be used, for example. Alternatively, only fatty acid amide may be used as the lubricant. An amount of the lubricant added is 0.1 wt % to 1.0 wt % relative to the amount of the soft magnetic metal particles. The amounts of the soft magnetic metal particles, the glass particles, and the lubricant are adjusted such that a mass of the glass particles becomes 0.5 to 20 times a mass of the lubricant. For kinds of the soft magnetic metal particles, the glass particles, and the lubricant, Japanese Patent Application Publication No. 2017-45926 should be referred to.

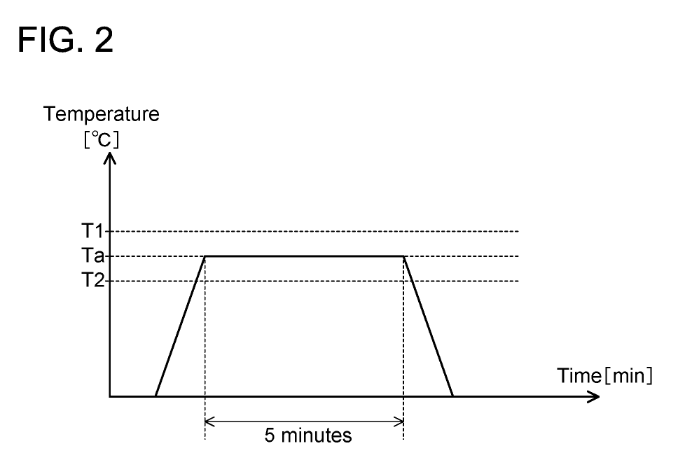

As illustrated in FIG. 2, a mixture of the soft magnetic metal particles, the glass particles, and the lubricant is heated at a temperature Ta for about 5 minutes. The temperature Ta is lower than a softening point T1 of the glass particles and is higher than a melting point T2 of the lubricant.

When the soft magnetic metal particles, the glass particles, and the lubricant are mixed and heated, powder of coated metal particles is obtained in which surfaces of the soft magnetic metal particles are coated with the lubricant, and the glass particles are distributed in lubricant coating layers. The glass particles are added for improving strength of the pressed powder magnetic core. Meanwhile, the lubricant is added for making it easy to take a molded body out from a mold in the molding process to be described later.

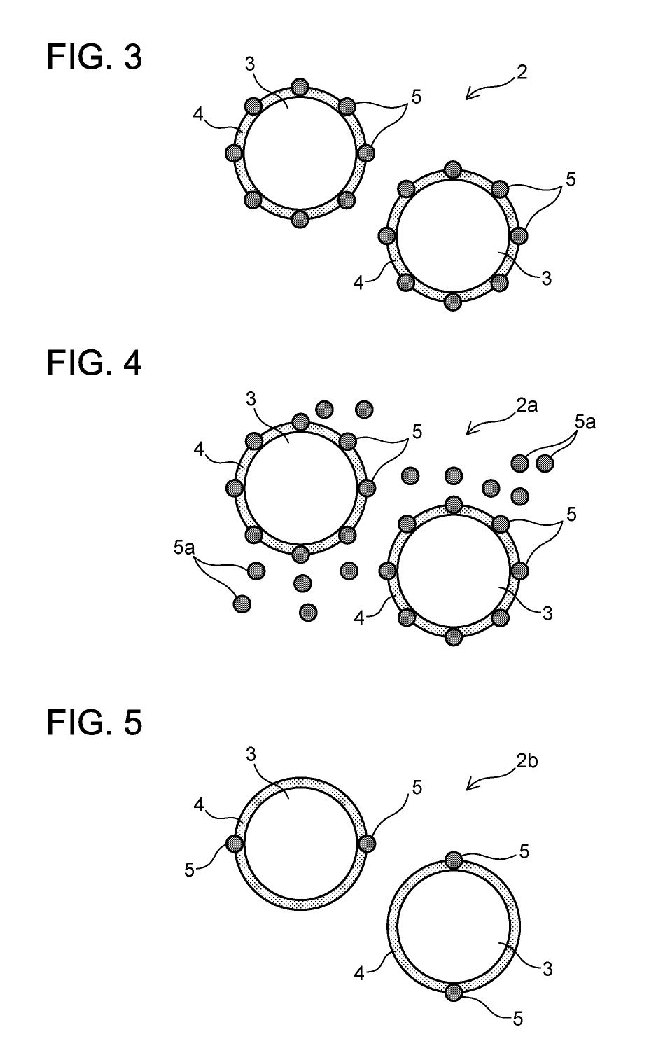

FIGS. 3 to 5 schematically illustrate differences between the powder of coated metal particles produced by the method of the embodiment and powders of coated metal particles of comparative examples. FIG. 3 is a schematic diagram of coated metal particles 2 produced by the method of the embodiment. FIGS. 4 and 5 are schematic diagrams of the comparative examples. FIG. 4 is a schematic diagram of coated metal particles 2a in a case of a large amount of glass particles added, and FIG. 5 is a schematic diagram of coated metal particles 2b in a case of a small amount of glass particles added. Both in FIGS. 4 and 5, surfaces of soft magnetic metal particles 3 are coated with lubricant (lubricant layers 4), and glass particles 5 are distributed in the lubricant layers 4.

If the amount of the glass particles is too large, many glass particles 5a that are not caught in the lubricant layers 4 remain (FIG. 4). When such free glass particles remain, fluidity of the powder is lowered. If the amount of the glass particles is too small, the glass particles 5 distributed in the lubricant layers 4 becomes a few (FIG. 5). In this case, when adjacent coated metal particles 2b come into contact with each other, a surface of contact between the lubricant layers 4 thereof, which have a large surface tension, is increased and therefore the fluidity of the powder is lowered.

(Molding Process)

In the molding process, a mold that has an inner space with a shape of the magnetic core is filled with the powder of coated metal particles produced in the mixing and heating process, and the mold is heated. In the molding process, the mold is heated while a pressure is applied to the powder of coated metal particles in the mold. A pressure of 800 to 1600 MPa is applied to the powder of coated metal particles in the mold. During application of the pressure, the mold is maintained at 60 to 120 degrees Celsius. This process may be also called warm molding.

Next, a molded body that was taken out from the mold is annealed. In this process, the molded body (magnetic core) is placed in a nitrogen atmosphere at a temperature of 600 to 900 degrees Celsius for 10 to 60 minutes. In this manner, a pressed powder magnetic core is completed.

Test pieces of pressed powder magnetic core were produced with various amounts of the glass particles and the lubricant to examine a ratio of the amounts from which a favorable test piece is obtained. The results will be described below.

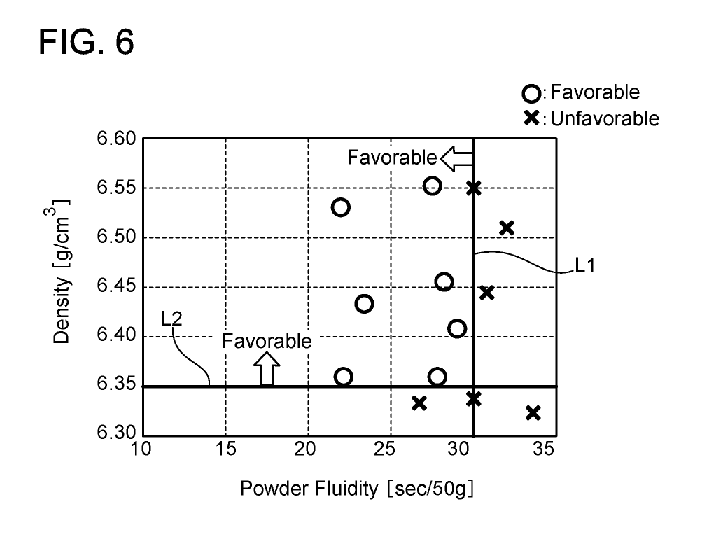

FIG. 6 is a graph in which its horizontal axis represents powder fluidity of powder obtained in the mixing and heating process and its vertical axis represents density of test pieces. Circles in the graph represent favorable test pieces, and crosses represent unfavorable test pieces. The unfavorable test pieces mean test pieces that are low in strength and are easily broken. The powder fluidity was measured by a method defined in JIS (Japan Industrial Standard) Z2502. Specifically, the powder fluidity was measured in the following method. 50 g of the powder was discharged from a bulk density measurement device at a room temperature. A diameter of a discharge outlet of the bulk density measurement device was 2.63 mm. Time taken until completion of the discharge was used as a value indicating the powder fluidity. The smaller the value is, the higher the fluidity is.

The result in FIG. 6 reveals that it is preferable that the powder fluidity is 30 [sec/50 g] or less and the density is 6.35 [g/cm³] or more. In FIG. 6, a left side with respect to a line L1 represents a range of the powder fluidity of 30 [sec/50 g] or less, and an upper side with respect to a line L2 represents a range of the density of 6.35 [g/cm³] or more.

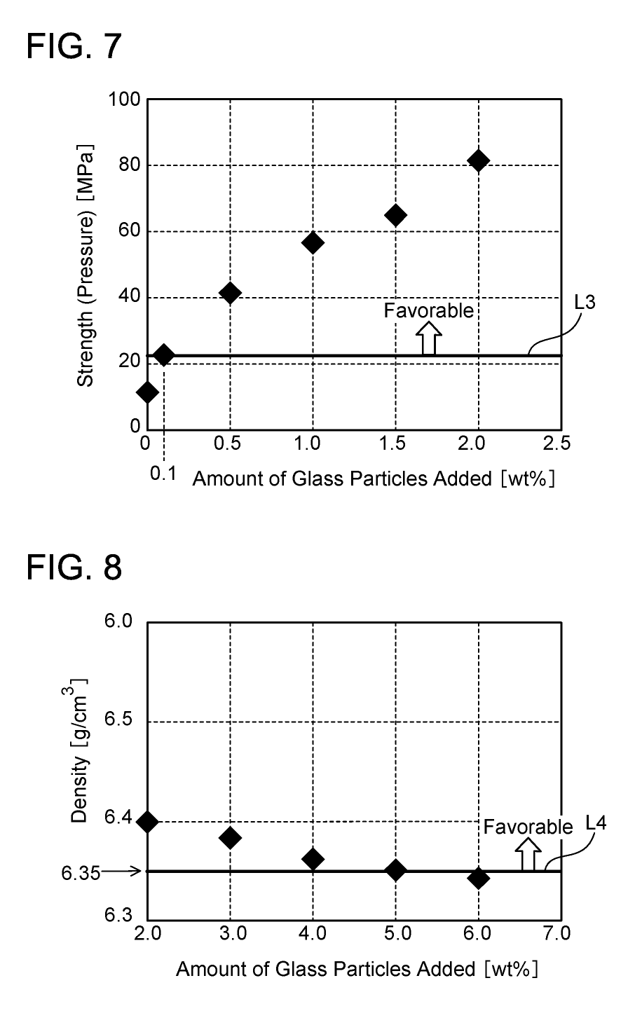

FIG. 7 is a graph in which its horizontal axis represents the amount of glass particles and its vertical axis represents strength of test pieces. A unit of the horizontal axis is a mass ratio [wt %] of the amount of glass particles relative to the amount of soft magnetic metal particles. Values on the vertical axis represent pressures by which the test pieces were broken in a test of applying pressure to the test pieces. This strength measurement method conforms to a method defined in JIS-Z2507. It is preferable that a core of a reactor has a strength of 20 MPa or more. With regard to this point, it was found that the amount of glass particles is preferably 0.1 wt % or more relative to the amount of soft magnetic metal particles. An upper side with respect to a bold line L3 in FIG. 7 corresponds to a range of 20 MPa or more.

FIG. 8 is a graph in which its horizontal axis represents the amount of glass particles and its vertical axis represents the density of test pieces. A unit of the horizontal axis is the same as that in FIG. 7. As described earlier, it is preferable that the density of test pieces is 6.35 g/cm³ or more. An upper side with respect to a bold line L4 in FIG. 8 corresponds to a range of the density of 6.35 g/cm³ or more. The density of 6.35 g/cm³ or more is achieved when the amount of glass particles is 5.0 wt % or less relative to the amount of soft magnetic metal particles.

From the results in FIGS. 7 and 8, a preferable range of the amount of low-melting-point glass particles is from 0.1 wt % to 5.0 wt % relative to the amount of soft magnetic metal particles. In the cases of FIGS. 7 and 8, the amount of lubricant is 0.6 wt % relative to the amount of soft magnetic metal particles.

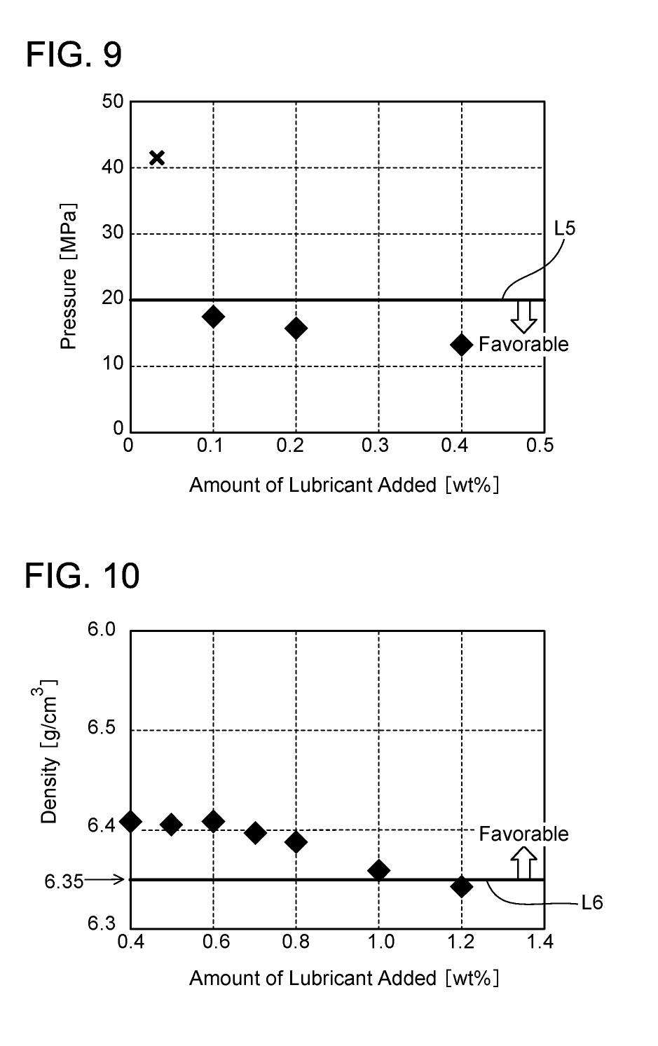

FIG. 9 is a graph in which its horizontal axis represents the amount of lubricant and its vertical axis represents pressure. A unit of the horizontal axis is a mass ratio [wt %] of the amount of the lubricant relative to the amount of the soft magnetic metal particles. Pressures on the vertical axis are pressures that were applied to test pieces when the test pieces were taken out from the mold. A smaller pressure means a more favorable result. When the amount of lubricant is lower than 0.1 wt %, the pressure becomes large. For example, when the amount of lubricant is 0.03 wt %, the test piece cannot be taken out from the mold unless a pressure exceeding 40 MPa is applied thereto (a cross in FIG. 9). A pressure for taking a test piece out from the mold is preferably 20 MPa or less. A lower side with respect to a bold line L5 in FIG. 9 corresponds to a range of pressure of 20 MPa or less. From the result of FIG. 9, it is preferable that the amount of lubricant is 0.1 wt % or more relative to the amount of soft magnetic metal particles.

FIG. 10 is a graph in which its horizontal axis represents the amount of lubricant and its vertical axis represents the density of test pieces. A unit of the horizontal axis is the same as that in FIG. 9. As described earlier, it is preferable that the density of test pieces is 6.35 g/cm³ or more. An upper side with respect to a bold line L6 in FIG. 10 corresponds to a range of the density of 6.35 g/cm³ or more. From the result of FIG. 10, the density of 6.35 g/cm³ or more is achieved when the amount of lubricant is 1.0 wt % or less relative to the amount of soft magnetic metal particles. From the results of FIGS. 9 and 10, a preferable range of the amount of lubricant is from 0.1 wt % to 1.0 wt % relative to the amount of soft magnetic metal particles. In the cases of FIGS. 9 and 10, the amount of low-melting-point glass particles is 1.5 wt % relative to the amount of soft magnetic metal particles.

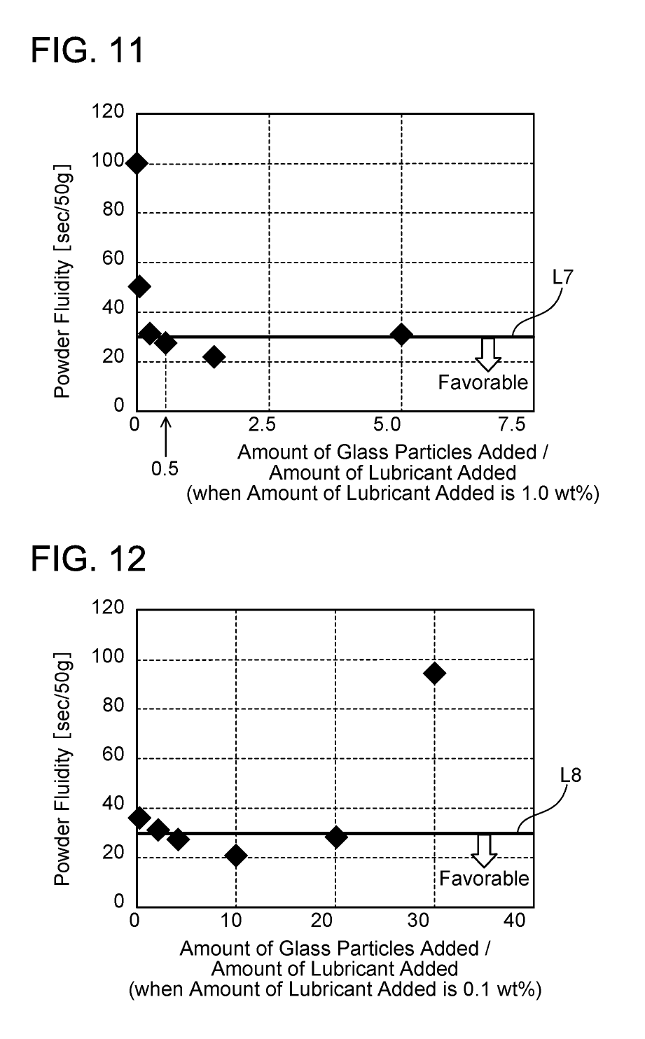

FIG. 11 is a graph in which its horizontal axis represents a ratio of the amount of glass particles to the amount of lubricant, and its vertical axis represents powder fluidity. FIG. 11 illustrates result obtained when the amount of lubricant was 1.0 wt %. As described earlier, it is preferable that the powder fluidity is 30 [sec/50 g] or less. A lower side with respect to a bold line L7 in FIG. 11 corresponds to a range of the powder fluidity of 30 [sec/50 g] or less. FIG. 11 shows that the powder fluidity is rapidly deteriorated when the ratio of the amount of glass particles to the amount of lubricant becomes lower than 0.5. The powder fluidity of 30 [sec/50 g] or less is achieved when the ratio of the amount of glass particles to the amount of lubricant is 0.5 or more.

FIG. 12 is a graph in which its horizontal axis represents a ratio of the amount of glass particles to the amount of lubricant, and its vertical axis represents powder fluidity. FIG. 12 illustrates result obtained when the amount of lubricant was 0.1 wt %. A lower side with respect to a bold line L8 in FIG. 12 corresponds to a range of the powder fluidity of 30 [sec/50 g] or less. FIG. 12 shows that the powder fluidity is rapidly deteriorated when the ratio of the amount of glass particles to the amount of lubricant exceeds 20. The powder fluidity of 30 [sec/50 g] or less is achieved when the ratio of the amount of glass particles to the amount of lubricant is 20 or less. From the results of FIGS. 11 and 12, it is preferable that the ratio of the amount of glass particles to the amount of lubricant is from 0.5 to 20.

In the manufacturing method of the pressed powder magnetic core, a ratio of the amount of glass particles to the amount of lubricant when it is the largest and when it is the smallest is important to achieve both good fluidity of the powder of coated metal particles and ease of filling the mold with the powder.

From the above results, the following numerical ranges are preferable for the amounts of glass particles and lubricant. The amount of glass particles added is preferably 0.1 wt % to 5.0 wt % relative to the amount of soft magnetic metal particles. The amount of lubricant added is preferably 0.1 wt % to 1.0 wt % relative to the amount of soft magnetic metal particles. A mass of the glass particles is preferably 0.5 to 20 times a mass of the lubricant, and is more preferably 0.5 to 3.0 times the mass of lubricant.

What is claimed is:

1. A method of manufacturing a pressed powder magnetic core, the method comprising:
mixing soft magnetic metal particles, low-melting-point glass particles and lubricant and heating a mixture of the soft magnetic metal particles, the low-melting-point glass particles and the lubricant at a temperature that is higher than a melting point of the lubricant and is lower than a softening point of the low-melting-point glass particles so as to obtain powder of coated metal particles in which surfaces of the soft magnetic metal particles are coated by the lubricant and the low-melting-point glass particles are distributed in coating layers of the lubricant;
filling a mold with the powder;
press-molding the powder in the mold; and
annealing the press-molded powder,
wherein, in the pressed powder magnetic core,
an amount of the low-melting-point glass particles is 0.1 wt % to 5.0 wt % relative to an amount of the soft magnetic metal particles,
an amount of the lubricant is 0.1 wt % to 1.0 wt % relative to the amount of the soft magnetic metal particles, and
a mass of the low-melting-point glass particles is 0.5 to 20 times a mass of the lubricant.

2. The method of claim 1, wherein the mass of the low-melting-point glass particles is 0.5 to 3.0 times the mass of the lubricant.

3. The method of claim 1, wherein the powder is press-molded in the mold while heating the mold at a temperature between 60 to 120 degrees Celsius.
